(19) United States
(12) Patent Application Publication
(10) Pub. No.: US 2019/0011739 A1
(43) Pub. Date: Jan. 10, 2019

(54) DISPLAY PANEL AND DISPLAY APPARATUS

(71) Applicants: HKC Corporation Limited, Shenzhen (CN); Chongqing HKC Optoelectronics Technology Co., Ltfd, Chongqing (CN)

(72) Inventor: CHUNG-KUANG CHIEN, Chongqing (CN)

(21) Appl. No.: 15/744,794

(22) PCT Filed: Apr. 20, 2017
(86) PCT No.: PCT/CN2017/081232

§ 371 Date: Jan. 13, 2018

(30) Foreign Application Priority Data
Dec. 29, 2016 (CN) 2016112663230

(51) Int. Cl. G02F 1/1341; G02F 1/1335; G02F 1/1339

(52) U.S. Cl. CPC G02F 1/1341; G02F 1/1339; G02F 1/133514

(57) ABSTRACT

The present invention discloses a display panel and a display apparatus. The display panel includes a first substrate, a second substrate opposite to the first substrate, a sealant and at least two spacers. The sealant is positioned between the first substrate and the second substrate, and is positioned on the sealing areas of the first substrate and the second substrate, so as to seal the first substrate and the second substrate. At least two spacers are positioned between the first substrate and the second substrate, and include a first spacer disposed on the sealing areas of the first substrate and the second substrate.

### TECHNICAL FIELD

The present invention relates to the technical field of displays, and particularly relates to a display panel and a display apparatus.

### BACKGROUND

Liquid crystal display apparatuses have numerous advantages, such as a thin body, power savings, no radiation, etc., and are widely used. Most liquid crystal display apparatuses in the current market are backlit liquid crystal display apparatuses, each including a liquid crystal panel and a backlight module. Working principle of the liquid crystal panel is that liquid crystals are put in two parallel glass substrates, and a driving voltage is applied to two glass substrates to control rotational direction of the liquid crystals, to refract light rays of the backlight module to generate a picture.

Thin film transistor liquid crystal display apparatuses (TFT-LCD apparatuses) currently maintain a leading status in the display field because of low power consumption, excellent picture quality, high production yield, and other properties. Similarly, the TFT-LCD apparatus comprises a liquid crystal panel and a backlight module. The liquid crystal panel comprises a color filter substrate (CF substrate) and a thin film transistor substrate (TFT substrate), and transparent electrodes on relative inner sides of the above substrates. A layer of liquid crystals (LC) is positioned between two substrates. The liquid crystal panel changes a polarized state of light by controlling direction of the LCs through an electric field, for penetration and obstruction of a light path via a polarized plate to display.

In manufacturing existing liquid crystal panels, after matching of the color filter substrate and the thin film transistor substrate, a sealant also needs to be arranged at edges of the thin film transistor substrate and the color filter substrate, sealing the color filter substrate and the thin film transistor substrate. Current sealants have poor supporting nature, the sealant cannot be used in supporting the edges of the thin film transistor substrate and the color filter substrate.

### SUMMARY

The aim of the present invention is to provide a display panel for realizing good edge support.

In addition, the present invention also provides a display apparatus comprising the above display panel.

The aim of the present invention is realized by the following technical solution.

According to one aspect of the present invention, the present invention discloses a display panel comprising:

a first substrate,

a second substrate arranged opposite to the first substrate,

a sealant positioned between the first substrate and the second substrate and positioned on sealing areas of the first substrate and the second substrate for sealing the first substrate and the second substrate, and

at least two spacers positioned between the first substrate and the second substrate, wherein the spacers comprise a first spacer disposed on the sealing areas of the first substrate and the second substrate.

The first spacer is disposed at an inner side of the sealant, and is closely attached to the sealant. This is a specific way of arranging the first spacer and the sealant, the first spacer and other spacers can be formed in the same manufacturing process, and it is more convenient to arrange the sealant from an outer side of the first spacer. Due to close attachment of the sealant and the first spacer, not only the sealing of the sealant is better, but also the support of the first spacer is better.

The first spacer is disposed at the outer side of the sealant, and is closely attached to the sealant. This is another specific way of arranging the sealant and the first spacer. Due to close attachment of the sealant and the first spacer, not only the sealing of the sealant is better, but also the support of the first spacer is better.

The first spacer is disposed in the sealant. This is another specific way of arranging the sealant and the first spacer. Due to arrangement of the first spacer in the sealant, not only the sealing of the sealant is better, but also the support of the first spacer is better.

The sealant is spaced by the first spacer, so that the sealant is divided into a first sealant and a second sealant. The first sealant is positioned at an outer side of the first spacer, and the second sealant is positioned at an inner side of the first spacer.

A color filter is disposed on the first substrate. A pixel structure is disposed on the second substrate. Width of the first sealant gradually widens from the first substrate to the second substrate, width of the second sealant gradually widens from the first substrate to the second substrate, and width of the first spacer gradually narrows from the first substrate to the second substrate. Due to the arrangement, the sealant plays a better role in sealing under the premise of realizing better support of the first spacer.

The sealant is a black sealant. The black sealant has alight blocking nature, to prevent the light leakage of the edges of the first substrate and the second substrate.

The display panel also comprises a light shading object, and the first spacer is made from a same material as the light shading object. The light shading object has a light blocking nature, and since the first spacer is made from a same material as the light shading object, the first spacer has the light blocking nature. By common action of the sealant and the first spacer, to improve the light shading effect for edges of the first substrate and the second substrate, and the prevention of light leakage of the display panel is better.

The first spacer gradually narrows from one end thereof to the other end. Due to the arrangement of the first spacer, the support of the first spacer is good.

According to another aspect of the present invention, the present invention also discloses a display apparatus comprising the above display panel.

The support for the edge of the display panel in the prior art is poor. Compared with the prior art, the present invention has the technical effects as follows.

For the display panel of the present invention, the sealant and the first spacer are disposed on the sealing areas of the first substrate and the second substrate, and the sealant can be used to seal the edges of the first substrate and the second substrate. The first spacer and the sealant play a common role in supporting the first substrate and the second substrate on the sealing areas. By supporting of the first spacer to the sealing areas of the first substrate and the second substrate, a better support is realized for the sealing areas of the first substrate and the second substrate, thereby realizing good support for the sealing areas of the display panel, and no deformation is easily caused.

In addition, the first spacer and other spacers in the present invention can be formed in a same manufacturing process. After the first spacer is disposed on the sealing areas of the first substrate and the second substrate, the sealant is laid in a periphery of the first spacer. Thus, there is no additional process added in manufacturing the display panel, the support for the sealing areas of the display panel is also realized by the first spacer, thereby realizing good support for the sealing areas of the display panel, and no deformation is easily caused.

### BRIEF DESCRIPTION OF DRAWINGS

As a portion of the specification, figures included are used for further understanding the embodiments of the present application, demonstrating the implementation mode of the present application, and explaining the principle of the present application together with text description. Apparently, the figures in the following description are only some embodiments of the present application. For those of ordinarily skill in the art, under the premise of no innovative efforts, other figures also can be obtained according to these figures. In the figures:

FIG. 1 is a structural schematic diagram of a display panel of an embodiment of the present invention.

FIG. 2 is a structural schematic diagram of a display panel of an embodiment of the present invention.

FIG. 3 is a structural schematic diagram of a display panel of an embodiment of the present invention.

FIG. 4 is a structural schematic diagram of a display panel of an embodiment of the present invention.

FIG. 5 is a schematic diagram of a display apparatus of an embodiment of the present invention.

Wherein: 10. Display apparatus, 100. display panel, 110. first substrate, 111. color filter, 120. second substrate, 121. pixel structure, 130. spacer, 131. first spacer, 132. other spacers, 140. sealant, 141. first sealant, and 142. second sealant.

### DETAILED DESCRIPTION

Specific structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated apparatus or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature limited by “first” and “second” can explicitly or impliedly include one or more features. In the description of the present application, the meaning of “a plurality of” is two or more unless otherwise specified. In addition, the term “comprise” and any variant are intended to cover non-exclusive inclusion.

It should be noted in the description of the present application that, unless otherwise specifically regulated and defined, terms such as “installation,” “bonded,” and “bonding” shall be understood in broad sense, and for example, may refer to fixed bonding or detachable bonding or integral bonding; may refer to mechanical bonding or electrical bonding; and may refer to direct bonding or indirect bonding through an intermediate medium or inner communication of two elements. For those of ordinary skill in the art, the meanings of the above terms in the present application may be understood according to specific conditions.

The terms used herein are intended to merely describe specific embodiments, not to limit the exemplary embodiments. Unless otherwise noted clearly in the context, singular forms “one” and “single” used herein are also intended to comprise plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

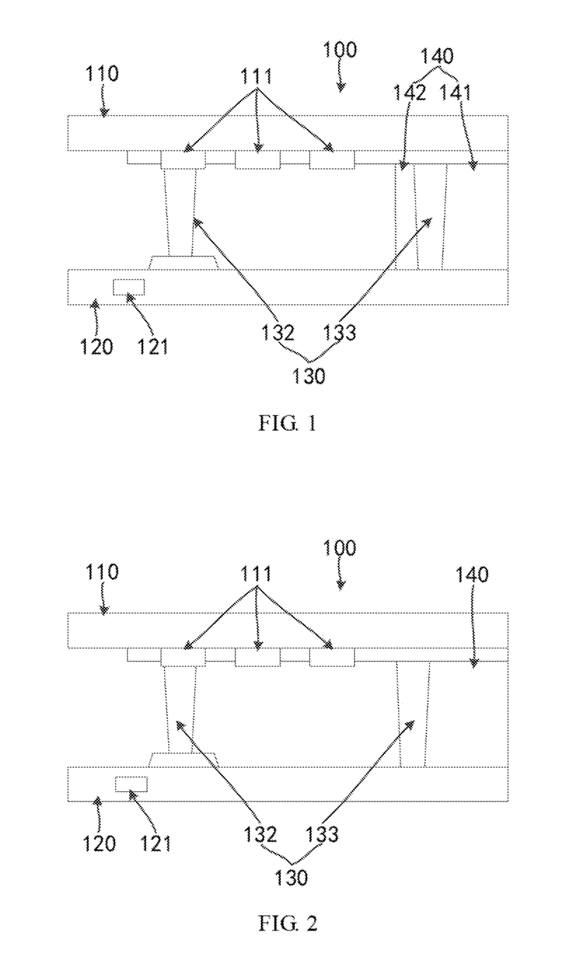

The display panel and the display apparatus of the present invention are described with reference to FIG. 1 to FIG. 5.

In order to support edges of the display panel, applicant has designed a display panel. As shown in FIG. 1, a first substrate and a second substrate are sealed by arranging sealant at edges of the first substrate and the second substrate of the display panel, and fiber or glass fiber is mixed with the sealant to improve support of the sealant for the edges of the first substrate and the second substrate.

But, in the invention of the applicant, in using the fiber to improve the support of the sealant for the edge of the display panel in actual testing, the following problems have arisen:

A step of mixing the fiber into the sealant needs to be added in the manufacturing process of the display panel.

Therefore, the above technical problems can be solved by another technical solution as follow.

The present invention is further detailed in combination with FIG. 1 to 5 and preferred embodiments.

According to an embodiment of the present invention, as shown in FIG. 1 to FIG. 4, the embodiment of the present invention discloses a display panel 100, comprising a first substrate 110, a second substrate 120, at least two spacers 130, and a sealant 140.

The first substrate 110 is arranged opposite to the second substrate 120. In the embodiment of the present invention, for example, the first substrate 110 is a color filter substrate, and the second substrate 120 is a thin film transistor substrate. When the first substrate is the color filter substrate, a color filter 111 is disposed on the first substrate 110, wherein the color filter 111 comprises a R color filter, a G color filter, and a B color filter. It needs to be noted that the color filter 111 in the present embodiment is not limited to the R color filter, the G color filter and the B color filter, and also can comprise other color filters, such as a W color filter and a Y color filter. When the second substrate is the thin film transistor substrate, a pixel structure 121 is disposed on the second substrate 120. However, it needs to be noted that, the arrangement of the first substrate and the second substrate is not limited to this. For example, the first substrate is, e.g., the thin film transistor substrate, and the second substrate is, e.g., the color filter substrate. For another example, the pixel structure and the color filter are disposed on the first substrate or the second substrate.

The display panel 100 of the present embodiment is, for example, a curved panel. However, it needs to be noted that the display panel of the present embodiment is not limited to this.

In the present embodiment, the sealant 140 is positioned between the first substrate 110 and the second substrate 120, and is positioned on edges of the first substrate 110 and the second substrate 120, so as to seal the first substrate 110 and the second substrate 120 (sealing areas of the edges). The sealant 140 of the present embodiment preferably adopts black sealant. The black sealant not only can seal the first substrate 110 and the second substrate 120, but also has light blocking nature and provides good light blocking, thereby preventing light leakage from the edges of the first substrate 110 and the second substrate 120, and realizing better display of the display panel 100. Certainly it needs to be noted that, the sealant of the present embodiment is not limited to the black sealant.

In the present embodiment, at least two of the spacers 130 are positioned between the first substrate 110 and the second substrate 120, and are spacedly arranged. The spacers 130 of the present embodiment comprise a first spacer 131 and other spacers 132 (other spacers can be one, two or more). The first spacer 131 is disposed on the sealing areas of the first substrate 110 and the second substrate 120. Further, the first spacer 131 is adjacent to the sealant 140, and the first spacer 131 and the sealant 140 play a common role in supporting the first substrate 110 and the second substrate 120 on the sealing areas. By the first spacer 131 supporting the first substrate 110 and the second substrate 120, a better support is realized for the sealing areas of the first substrate 110 and the second substrate 120, thereby realizing good support for the sealing areas of the display panel 100, and no deformation is easily caused.

In the present embodiment, the first spacer 131 and other spacers 132 can be formed in a same manufacturing process. After the first spacer 131 is positioned between the first substrate 110 and the second substrate 120, the sealant 140 is laid in a periphery of the first spacer 131, and then sealing and support for the edges of the first substrate 110 and the second substrate 120 can be realized. Thus, there is no additional process added in manufacturing the display panel, and the support for the sealing areas of the display panel 100 and the sealing of the sealant 140 for the display panel 100 are realized by the first spacer 131, thereby realizing good support for the sealing areas of the display panel 100, and no deformation is easily caused.

In the present embodiment, formation of the first spacer 131 and other spacers 132 is realized in a same manufacturing process, to save manufacturing processes, and save materials costs. The first spacer is made from a same material as other spacers.

In addition, the present embodiment uses the first spacer to support the sealed area of the edge of the display panel, because the first spacer has a wide range of applications, has no limitations, and is applicable to various display panels.

However, it needs to be noted that, in the present embodiment, the first spacer and the other spacers may not be formed in the same manufacturing process. For example, the first spacer is made from the same material as the light shading object (such as a black matrix), and the first spacer and the light shading object are manufactured in a same manufacturing process. The light shading object has light blocking nature. In the embodiment of the present invention, the first spacer is made from the same material as the light shading object, the first spacer and the light shading object are manufactured in the same manufacturing process, so that the first spacer has light blocking nature. By common action of the sealant and the first spacer, thereby improving light shading for the edges of the first substrate and the second substrate, and the prevention of light leakage of the display panel is better.

In addition, the first spacer of the embodiment of the present invention also can be formed in a single manufacturing process.

In the present embodiment, a black color filter spacer (BCS) material is preferably selected for the first spacer. The material not only can play a role in supporting, but also has good light shading property. Certainly, it needs to be noted that the first spacer in an embodiment of the present invention also can be made of other materials.

In the present embodiment, as shown in FIG. 1, the first spacer 131 is disposed in the sealant 140. Specifically, after arrangement of the first spacer, the black sealant can be laid in a periphery of the first spacer to form the sealant. The sealant 140 is spaced by the first spacer 131, so that the sealant 140 is divided into a first sealant 141 and a second sealant 142. The first sealant 141 is positioned at an outer side of the first spacer 131, and the second sealant 142 is positioned at an inner side of the first spacer 131. Due to the arrangement, not only sealing of the sealant is better, but also the support of the first spacer is better. Further, width of the first sealant 141 gradually widens from the first substrate 110 to the second substrate 120, width of the second sealant 142 gradually widens from the first substrate 110 to the second substrate 120, and width of the first spacer 131 gradually narrows from the first substrate 110 to the second substrate 120. Due to the arrangement, the sealant plays a better role in sealing under the premise of realizing better support of the first spacer. The first spacer 131 is disposed in the sealant 140, which is a specific way of arranging the sealant 140 and the first spacer 131. However, it needs to be noted that, in the embodiment of the present invention, the first spacer also can be disposed at other portions of the sealant, specifically as follows:

### Example 1

As shown in FIG. 2, the first spacer 131 is disposed at an inner side of the sealant 140, and is closely attached to the sealant 140. Specifically, after arrangement of the first spacer, the black sealant can be laid at an inner side of the first spacer to form the sealant. The sealant and the first spacer are closely attached, thereby realizing not only better sealing of the sealant, but also better support of the first spacer.

### Example 2

As shown in FIG. 3, the first spacer is disposed at an outer side of the sealant, and is closely attached to the sealant. Specifically, after arrangement of the first spacer, the black sealant can be laid at an outer side of the first spacer to form the sealant. The sealant and the first spacer are closely attached, thereby realizing not only better sealing of the sealant, but also better support of the first spacer.

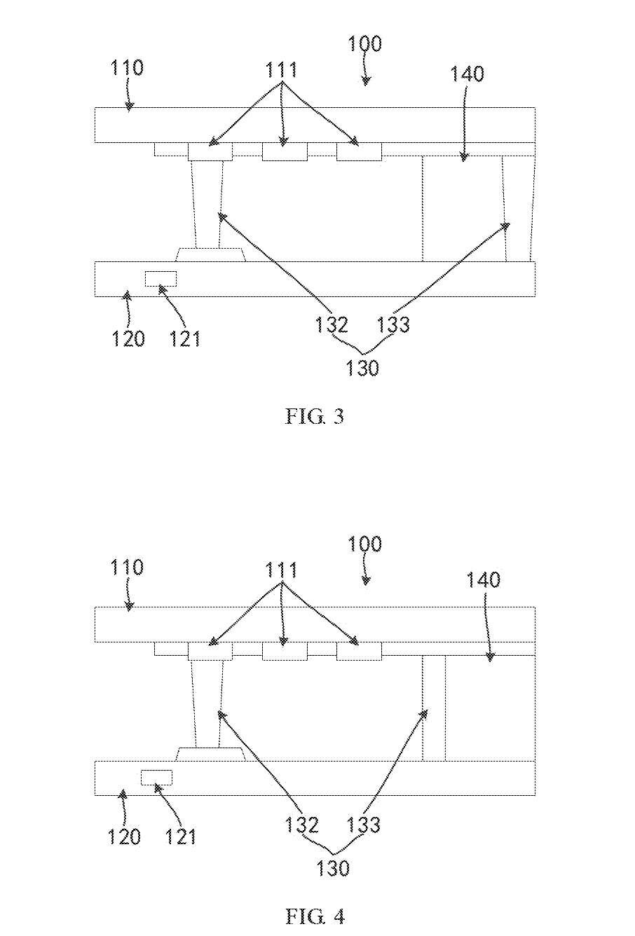

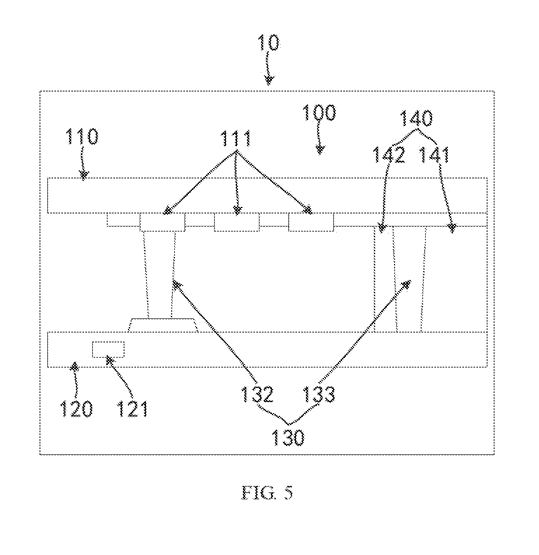

In the present embodiment, the first spacer 131 also can be made into other shapes and structures, for example, as shown in FIG. 4, the first spacer is made into a rectangular structure, so that one end of the first spacer to the other end thereof can be same in size.

In the embodiment of the present invention, the display panel can be selected from one of the following: twisted nematic (TN) type or super twisted nematic (STN) type, in-plane switching (IPS) type, vertical alignment (VA) type and high vertical alignment (HVA) type and curved type panel.

As shown in FIG. 5, the present invention also discloses a display apparatus 10. The display apparatus 10 comprises a display panel 100 and can be either a liquid crystal display or an OLED display. When the display apparatus 10 of the embodiment of the present invention is the liquid crystal display apparatus, the liquid crystal display apparatus comprises a backlight module, and the backlight module can be used as a light source and is used to supply sufficient brightness and a uniformly-distributed light source. The backlight module of the present embodiment can be either front-light type or backlight type, but it needs to be noted that the backlight module of the embodiment is not limited to this, wherein the display panel 100 of the display apparatus of the present embodiment is only a specific structure of the embodiment, and for more details, the above embodiments and FIG. 1 can be seen. However, it needs to be noted that the structure of the display panel in the display apparatus of the embodiment is not limited to this, the above embodiments and FIG. 2 to FIG. 4 also can be seen, and details for the display panel will not be described herein.

The above contents are further detailed descriptions of the present application in combination with specific preferred embodiments. However, the specific implementation of the present application shall not be considered to be only limited to these descriptions. For those ordinary skilled in the art to which the present application belongs, several simple deductions or replacements may be made without departing from the conception of the present application, all of which shall be considered to belong to the protection scope of the present application.

1. A display panel, comprising:
a first substrate;
a second substrate arranged opposite to the first substrate;
a sealant positioned between the first substrate and the second substrate and positioned on sealing areas of the first substrate and the second substrate for sealing the first substrate and the second substrate; and
at least two spacers positioned between the first substrate and the second substrate, wherein the spacers comprise a first spacer disposed on the sealing areas of the first substrate and the second substrate.

2. The display panel according to claim 1, wherein the first spacer is disposed at an inner side of the sealant, and is closely attached to the sealant.

3. The display panel according to claim 1, wherein the first spacer is disposed at an outer side of the sealant, and is closely attached to the sealant.

4. The display panel according to claim 1, wherein the first spacer is disposed in the sealant.

5. The display panel according to claim 4, wherein the sealant is spaced by the first spacer, to divide the sealant into a first sealant and a second sealant; and the first sealant is positioned at an outer side of the first spacer, and the second sealant is positioned at an inner side of the first spacer.

6. The display panel according to claim 5, wherein a color filter is disposed on the first substrate; and a pixel structure is disposed on the second substrate;
wherein width of the first sealant gradually widens from the first substrate to the second substrate, width of the second sealant gradually widens from the first substrate to the second substrate, and width of the first spacer gradually narrows from the first substrate to the second substrate.

7. The display panel according to claim 6, wherein the sealant is black sealant, the display panel also comprises a light shading object, and the first spacer is made from a same material as the light shading object.

8. The display panel according to claim 1, wherein the sealant is black sealant.

9. The display panel according to claim 1, wherein the display panel also comprises a light shading object, and the first spacer is made from a same material as the light shading object.

10. The display panel according to claim 1, wherein width of the first spacer gradually narrows from one end thereof to the other end.

11. A display apparatus comprises a display panel comprising:
a first substrate;
a second substrate arranged opposite to the first substrate;
a sealant positioned between the first substrate and the second substrate and positioned on sealing areas of the first substrate and the second substrate for sealing the first substrate and the second substrate; and
at least two spacers positioned between the first substrate and the second substrate, wherein the spacers comprise a first spacer disposed on the sealing areas of the first substrate and the second substrate.

12. The display apparatus according to claim 11, wherein the first spacer is disposed at an inner side of the sealant, and is closely attached to the sealant.

13. The display apparatus according to claim 11, wherein the first spacer is disposed at an outer side of the sealant, and is closely attached to the sealant.

14. The display apparatus according to claim 11, wherein the first spacer is disposed in the sealant.

15. The display apparatus according to claim 14, wherein the sealant is spaced by the first spacer, to divide the sealant into a first sealant and a second sealant; and the first sealant is positioned at an outer side of the first spacer, and the second sealant is positioned at an inner side of the first spacer.

16. The display apparatus according to claim 15, wherein a color filter is disposed on the first substrate; and a pixel structure is disposed on the second substrate;
wherein width of the first sealant gradually widens from the first substrate to the second substrate, width of the second sealant gradually widens from the first substrate to the second substrate, and width of the first spacer gradually narrows from the first substrate to the second substrate.

17. The display apparatus according to claim 16, wherein the sealant is black sealant, the display panel also comprises a light shading object, and the first spacer is made from a same material as the light shading object.

18. The display apparatus according to claim 11, wherein the sealant is black sealant.

19. The display apparatus according to claim 11, wherein the display panel also comprises a light shading object, and the first spacer is made from a same material as the light shading object.

20. The display apparatus according to claim 11, wherein width of the first spacer gradually narrows from one end thereof to the other end.
